(19) United States
(12) Patent Application Publication
(10) Pub. No.: US 2008/0259378 A1
(43) Pub. Date: Oct. 23, 2008

(54) IMAGE FORMING APPARATUS AND CONTROL METHOD THEREOF

(75) Inventor: Takaaki Suzuki, Sunto-gun (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/099,861

(22) Filed: Apr. 9, 2008

Related U.S. Application Data
(60) Provisional application No. 60/912,206, filed on Apr. 17, 2007.

(51) Int. Cl. G06K 15/00

(52) U.S. Cl. 358/1.14

(57) ABSTRACT

The invention relates to an image forming apparatus capable of operating in a normal mode and a power-saving mode, and includes a control unit that includes a CPU and a memory, operates, in the power-saving mode, the CPU in a low power consumption state, and operates the memory in a self-refresh mode to hold data, and a power source circuit that supplies a power source voltage to each unit of the image forming apparatus in the normal mode, and stops power supply to a circuit unit whose operation is not required in the power-saving mode. When a return factor to the normal mode from the power-saving mode occurs, the control unit distinguishes whether a return to the normal mode is to be made.

### CROSS-REFERENCE TO RELATED APPLICATION

This application is based upon and claims the priority of U.S. Provisional Application No. 60/912,206, filed on Apr. 17, 2007, the entire contents of which are incorporated herein by reference.

### BACKGROUND OF THE INVENTION

1. Field of the Invention

The present invention relates to an image forming apparatus such as an MFP (Multi-Function Peripherals) which is a digital compound machine, a copier or a printer, and relates to the image forming apparatus having a normal mode and a power-saving mode a control method thereof.

2. Description of the Related Art

In general, in an image forming apparatus such as an MFP, a copier or a printer, from the viewpoint of environmental protection, reduction in power consumption has been attempted. For that purpose, the image forming apparatus is made to be capable of operating in a normal power mode and a power-saving mode.

For example, in the normal power mode (normal mode), power is supplied to respective units such as an operation panel, a scanner unit, and a printer unit, and a print process is performed, and in the standby state, the display of the operation panel is turned off, or the scanner unit and the printer unit are turned off or are placed in a sleep state to achieve the reduction in power consumption.

On the other hand, in the case where the image forming apparatus includes a network unit or a FAX unit, even at the power-saving mode, when the operation panel is operated, or an instruction of image formation or the like is received through the network unit or the FAX unit, it is necessary to immediately return to the normal mode. Thus, a CPU to control the operation of the image forming apparatus or a partial circuit is made to keep an on state even in the power-saving mode.

JP-A-2004-5029 discloses an image forming apparatus having a power-saving function. In this example, a main CPU and a sub-CPU having smaller power consumption than the main CPU are provided, and in a normal mode, the main CPU controls the operation of respective units, and in a power-saving mode, the sub-CPU controls an operation panel, a network unit, a FAX unit and the like.

However, the above example requires the dedicated sub-CPU operated at the power-saving mode, the change in hardware is large as compared with a conventional apparatus, and the cost is resultantly increased. Besides, since the two control units of the main CPU and the sub-CPU are provided, the control system becomes complicated, and there is room for further improvement in the reduction of power consumption.

### SUMMARY OF THE INVENTION

The present invention has an object to provide an image forming apparatus which can effectively reduce power consumption and a control method thereof.

According to an aspect of the present invention, an image forming apparatus operating in a normal mode and a power-saving mode having smaller power consumption than the normal mode, comprising:

a control unit that includes a CPU and a memory, controls the image forming apparatus in the normal mode and the power-saving mode, operates the CPU in a low power consumption state and operates the memory in a self-refresh mode to hold data in the power-saving mode; and

a power source circuit that supplies a power source voltage to each unit of the image forming apparatus in the normal mode, and stops power supply to a circuit unit whose operation is not required in the power-saving mode,

wherein the control unit monitors a state of the image forming apparatus, and when a return factor to the normal mode from the power-saving mode occurs, the control unit operates the CPU and the memory in a normal state to distinguish whether a return to the normal mode is to be made, and returns the image forming apparatus to the normal mode according to the distinguishing result.

### DESCRIPTION OF THE DRAWINGS

FIG. 1 is a structural view showing an image forming apparatus of an embodiment of the invention.

FIG. 2 is a block diagram of a control system of the image forming apparatus of the embodiment of the invention.

FIG. 3 is a flowchart for explaining an operation of the image forming apparatus of the embodiment of the invention.

### DETAILED DESCRIPTION OF THE INVENTION

Throughout this description, the embodiments and examples shown should be considered as exemplars, rather than limitations on the apparatus of the present invention.

Hereinafter, an embodiment of the invention will be described in detail with reference to the drawings. Incidentally, in the respective drawings, the same part is denoted by the same reference numeral.

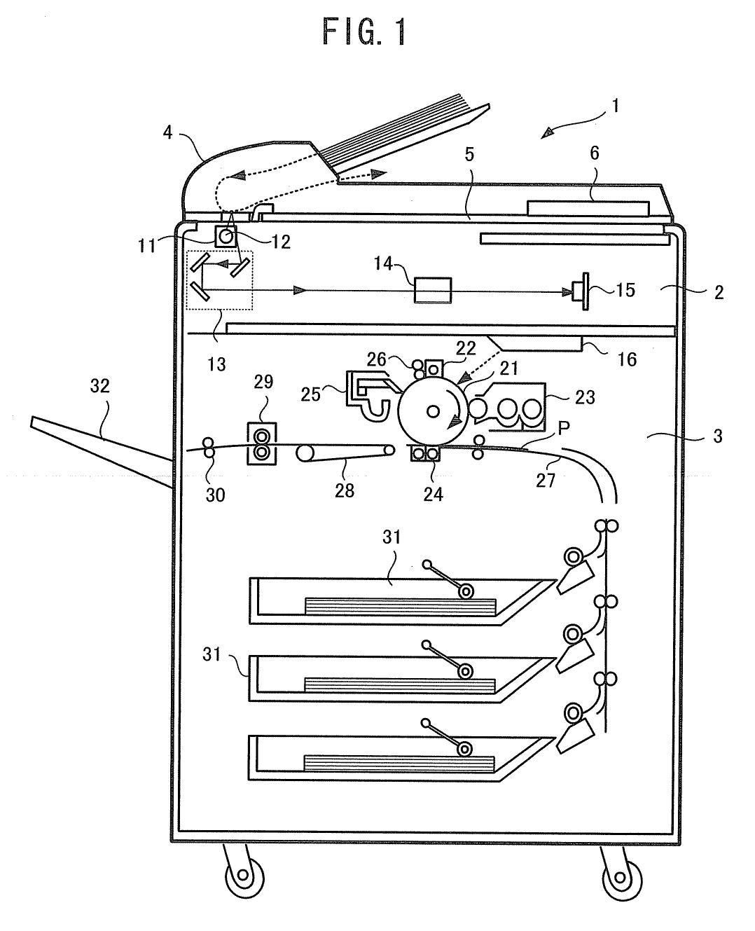

FIG. 1 is a structural view showing an embodiment of an image forming apparatus of the invention. Incidentally, in the following description, although the description will be made while an MFP (Multi-Function Peripherals) which is a compound machine is used as an example, the invention can also be applied to another image forming apparatus such as a printer or a copier.

An image forming apparatus 1 includes a scanner unit 2 and a printer unit 3. Further, an auto document feeder (ADF) 4, a transparent document table 5, and an operation panel 6 are provided at the upper part of the image forming apparatus 1. The scanner unit 2 is for reading an image of an original document, and the printer unit 3 is for forming an image on a sheet based on the read data. The scanner unit 2 and the printer unit 3 constitute an image forming unit.

The scanner unit 2 includes a carriage 11, an exposure lamp 12 provided in the carriage 11, a reflection mirror 13, a lens 14, a CCD 15 (Charge Coupled Device) to capture reflected light from the reflection mirror 13, and a laser unit 16.

In the scanner unit 2, in order to read the original document sent by the auto document feeder 4 or the original document placed on the document table 5, light from the exposure lamp 12 provided in the carriage 11 is irradiated to the original document from below the document table 5, and the reflected light from the original document is captured by the CCD 15 through the reflection mirror 13 and the lens 14.

Image information captured by the CCD 15 is outputted as an analog signal. The analog signal is converted into a digital signal, and is further subjected to an image process, and image data is generated. The image data is supplied to the laser unit 16, and a laser beam is generated from the laser unit 16 in accordance with the image data.

The printer unit 3 includes a photoconductive body 21, and includes a charging device 22, a developing device 23, a transfer device 24, a cleaner 25, and a charge-removal lamp 26 around the photoconductive body 21 along the rotation direction thereof. The laser beam from the laser unit 16 is irradiated to the photoconductive body 21, and an electrostatic latent image corresponding to the image information of the original document is formed and held on the outer peripheral surface of the photoconductive body 21.

When image formation is started, the charging device 22 discharges at a specified discharge position, and causes the outer peripheral surface of the rotating photoconductive body 21 to be charged with a specified electrical charge uniformly in the axial direction. Next, a laser beam is irradiated to the photoconductive body 21 from the laser unit 16, and an electrostatic latent image is formed and held on the outer peripheral surface of the photoconductive body 21.

Besides, a developer (for example, toner) is supplied from the developing device 23 to the outer peripheral surface of the photoconductive body 21, and the electrostatic latent image is converted into a toner image and is developed. In the developing device 23, a developing roller is rotatably provided to be opposite to the photoconductive body 21, and the toner is supplied to the photoconductive body 21 by the rotation of the developing roller.

The toner image formed on the outer peripheral surface of the photoconductive body 21 is electrostatically transferred to a sheet P by the transfer device 24. The sheet P is transported from an after-mentioned paper feed device 31 through a transport path 27. The toner not transferred but remaining on the photoconductive body 21 is removed by the cleaner 25 positioned downstream of the photoconductive body 21 in the rotation direction, and then, residual electrical charge on the outer peripheral surface of the photoconductive body 21 is removed by the charge-removal lamp 26.

Incidentally, the structure of the printer unit 3 is not limited to the example shown in the drawing, and another system, for example, a system using an intermediate transfer belt can also be used.

On the other hand, in order to supply the sheet to the printer unit 3, the plurality of paper feed devices 31 are provided at the lower part of the printer unit 3. The sheet from the paper feed device 31 is transported to the transfer device 24 through the transport path 27.

The sheet P on which the toner image is transferred by the transfer device 24 is transported to a fixing device 29 via a transport belt 28. In the fixing device 29, a heat roller and a pressure roller are provided to be opposite to each other, and the sheet P passes through between the heat roller and the pressure roller, so that the toner image transferred on the sheet P is fixed to the sheet P.

A heater is disposed in the heat roller of the fixing device 29, and power is applied to the heater so that the heat roller is heated up to a specified temperature. The sheet P on which the toner image is fixed and the image formation is completed is ejected to a tray 32 by a paper ejection roller 30.

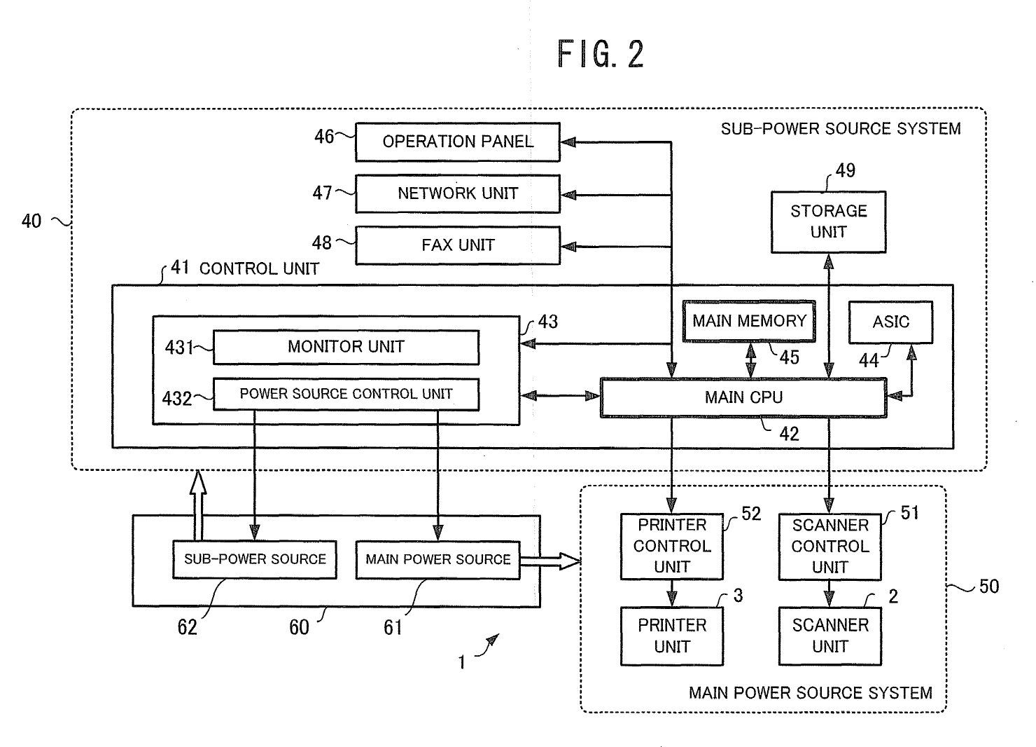

FIG. 2 is a block diagram of a control system of the image forming apparatus 1 of the embodiment of the invention. As shown in FIG. 2, the control system of the image forming apparatus 1 includes a sub-power source system 40 and a main power source system 50, and the sub-power source system 40 and the main power source system 50 are controlled by a control unit 41 provided in the sub-power source system 40.

First, the sub-power source system 40 will be described. The sub-power source system 40 includes the control unit 41. The control unit 41 controls the whole system of the image forming apparatus 1, and includes a main CPU (Central Processing Unit) 42, a mode control unit 43, an ASIC 44, a main memory 45 and the like.

The mode control unit 43 includes a monitor unit 431 and a power source control unit 432, and is connected to the main CPU 42. The ASIC 44 is an Application Specified IC for performing image processing and image working.

Besides, the main CPU 42 is connected with the main memory 45, and is connected with an operation panel 46, a network unit 47, a FAX unit 48 and a storage unit 49.

The main memory 45 stores programs and data based on which the main CPU 42 executes various processes, and can operate in a normal operation mode and a self-refresh mode. A program used in the case where the main CPU 42 performs a distinguishing process (described later) is stored in the main memory 45.

The operation panel 46 corresponds to the operation panel 6 of FIG. 1, and includes an operation unit having various keys, such as a numeric keypad, and a touch panel type display unit. Instructions of the number of prints, sheet size, magnification and the like are inputted from this operation panel 46.

The network unit 47 is for communicating with a host apparatus, such as a PC (Personal Computer), placed at a position remote from the image forming apparatus 1. The host apparatus is connected to the network unit 47 through a network such as a LAN, and can operate the image forming apparatus 1.

The FAX unit 48 is connected to a telephone line, transmits a signal of image information generated by the image forming apparatus 1 through the telephone line, and receives an image signal from outside. Accordingly, the network unit 47 and the FAX unit 48 constitute a communication unit to perform communication with an external apparatus. Besides, the storage unit 49 is for storing and reading image information.

On the other hand, the main power source system 50 includes a scanner control unit 51 to control the scanner unit 2, and a printer control unit 52 to control the printer unit 3. The main CPU 42 controls the scanner control unit 51 and the printer control unit 52, and the scanner control unit 51 and the printer control unit 52 control the operation of the image forming unit (the scanner unit 2 and the printer unit 3) based on the instruction of the main CPU 42.

The monitor unit 431 of the mode control unit 43 monitors the state of the image forming apparatus 1. That is, the monitor unit 431 monitors the state of the operation panel 46, the network unit 47, and the FAX unit 48, and controls the power source control unit 432 according to the presence or absence of operation in the operation panel 46, and the reception state of the network unit 47 or the FAX unit 48.

The power source control unit 432 of the mode control unit 43 is connected to a power source circuit 60. The power source circuit 60 includes a main power source 61 to supply a power source voltage to the main power source system 50 and a sub-power source 62 to supply a power source voltage to the sub-power source system 40, and the current capacity of the sub-power source 62 is set to be lower than the current capacity of the main power source 61.

The supply of the power source voltage to the main power source system 50 and the supply of the power source voltage to the sub-power source system 40 are controlled by the power source control unit 432, and the power source control unit 432 supplies power to the main power source system 50 or the sub-power source system 40 in response to the instruction from the monitor unit 431 under the control of the main CPU 42.

When the image forming apparatus 1 is in the normal mode, the voltage from the main power source 61 is supplied to the main power source system 50, and the voltage from the sub-power source 62 is supplied to the sub-power source system 40. On the other hand, when the image forming apparatus 1 is in the power-saving mode, the main power source 61 is stopped and the voltage supply to the main power source system 50 is stopped. That is, the supply of the power source voltage is stopped to the circuit unit, such as the main power source system 50, whose operation is not required in the power-saving mode.

Next, the state of each unit of the control system of FIG. 2 at the normal mode and the power-saving mode will be described.

The main CPU 42 operates by the voltage supplied from the sub-power source 62 in both the normal mode and the power-saving mode and controls the operation of each unit. In the normal mode, the main CPU 42 controls the scanner control unit 51 and the printer control unit 52 of the main power source system 50, and operates the scanner unit 2 and the printer unit 3.

On the other hand, at the power-saving mode, the main CPU 42 operates in a low power consumption state. The main CPU 42 operates in the normal mode, and can operate in a plurality of low power consumption states, such as DOZE, NAP and SLEEP, in which some operational functions are limited, and in the power-saving mode, the main CPU operates in, for example, the SLEEP mode having the highest power-saving effect.

The main CPU 42 placed in the SLEEP mode stops instruction execution and clock supply, and is returned to the normal mode when a previously set interrupt signal is inputted from outside.

That is, the monitor unit 431 monitors the presence or absence of the operation in the operation panel 46, and the reception state of a signal in the network unit 47 and the FAX unit 48, and when the operation panel 46 is operated by a user, or when the signal is received in the network unit 47 or the FAX unit 48, an interrupt signal is inputted to the main CPU 42. By this, the main CPU 42 returns to the normal state.

In the power consumption of the sub-power source system 40, the power consumption of the main CPU 42 accounts for a very large part, and accounts for nearly a half of all power consumption at the power-saving mode when the main CPU 42 remains in the normal state. Accordingly, when the main CPU is shifted to the SLEEP mode at the power-saving mode, the power consumption can be halved.

Besides, when the main CPU 42 returns to the normal state, the power source control unit 432 of the mode control unit 43 controls the power source circuit 60 by the instruction from the main CPU 42, causes the voltage from the main power source 61 to be supplied to the main power source system 50, and achieves a return to the normal mode.

On the other hand, the main memory 45 is in the self-refresh mode at the power-saving mode. The self-refresh mode of the main memory 45 is the mode in which a refresh process is automatically performed even if a clock or a command is not inputted from outside, and data is held. Incidentally, an OS (Operation System) for making a high-speed return when return is made to the normal mode is stored in the main memory 45.

When a shift to the power-saving mode is made, the main CPU 42 instructs the main memory 45 to shift to the self-refresh mode. By this, during the power-saving mode, the main memory 45 maintains the self-refresh mode by merely keeping the signal of the clock enable (CKE) terminal of the main memory 45 at a Low level.

By the shift to the self-refresh mode, the power consumption in the main memory 45 can be reduced to about 1/10 as compared with that at the normal time. That is, in the power-saving mode, since a program does not run on the main memory 45, the power consumption can be made small.

Besides, when a return factor to the normal mode from the power-saving mode occurs, the main CPU 42 performs a distinguishing process as to whether the return to the normal mode is to be made. A program based on which the CPU 42 performs the above distinguishing process is stored in the main memory 45, and at the distinguishing process, the self-refresh mode is released, and the main memory 45 is returned to the normal state.

Next, the operation of the image forming apparatus 1 of the embodiment of the invention will be described.

In the normal mode, a necessary power source voltage is supplied from the main power source 61 to the respective units of the main power source system 50, for example, the scanner control unit 51, the printer control unit 52, the scanner unit 2, and the printer unit 3. Besides, a power source voltage is supplied from the sub-power source 62 to the control unit 41, the operation panel 46, the network unit 47, the FAX unit 48, and the storage unit 49.

In the main power source system 50, in the print mode in which image formation is performed, the power source voltage is supplied from the main power source 61 to the scanner unit 2 and the printer unit 3, and the print process is performed. Besides, also in a standby mode in which image formation is immediately started when a print instruction is issued, the power source voltage is supplied from the main power source 61.

In the normal mode, when the operation panel 46 is operated, and an instruction to capture the image information of an original document is inputted, the main CPU 42 controls the scanner control unit 51. By this, the scanner unit 2 reads the image information of the original document, and stores the read image information in the storage unit 49. Alternatively, also in the case where image information is sent from a PC through the network 47, or image information is transmitted from the FAX unit 48, the image information is stored in the storage unit 49.

The image information stored in the storage unit 49 is transmitted to the printer control unit 52 under the control of the main CPU 42, and an image is formed by the printer unit 3.

On the other hand, in the power-saving mode, the power source control unit 432 controls the power source circuit 60 based on the control of the main CPU 42, and electric power is supplied from the sub-power source 62 to only the sub-power source system 40.

By this, power supply to the main power source system 50 is cut off, and a necessary power source voltage is supplied from the sub-power source 62 only to the respective units of the sub-power source system 40, for example, the control unit 41, the operation panel 46, the network unit 47, and the FAX unit 48. In the power-saving mode, since the image forming unit (the scanner unit 2 and the printer unit 3) stop the operation, the power consumption can be made small.

Besides, in the power-saving mode, the main CPU 42 shifts to the SLEEP mode, and the main memory 45 keeps the self-refresh mode. Besides, in the power-saving mode, the monitor unit 431 monitors the operation panel 46, the network unit 47 and the FAX unit 48.

When the user operates the operation panel 46 and an instruction of image formation is issued, or when the network unit 47 or the FAX unit 48 receives an instruction of image formation, the monitor unit 431 inputs an interrupt signal to the main CPU 42. By this, the main CPU 42 immediately returns to the normal mode. At this time, the main CPU 42 distinguishes the return factor, and in the case where the return to the normal mode is actually required, the return is made, and in the case where the return to the normal mode is not necessary, a return to the power-saving mode is made.

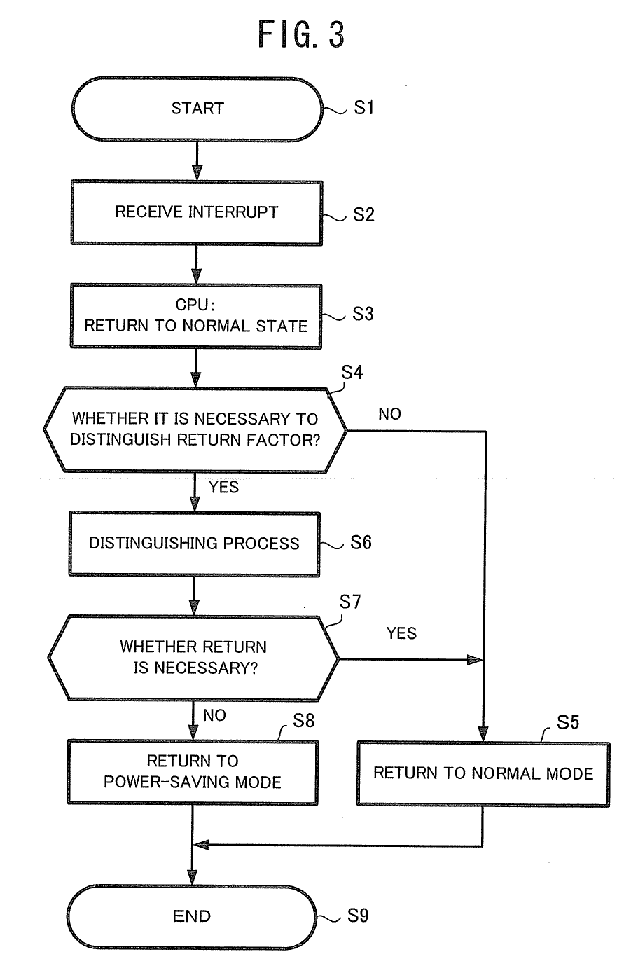

FIG. 3 is a flowchart for explaining the operation at the time when a return is made from the power-saving mode to the normal mode.

In FIG. 3, at start step S1, the image forming apparatus 1 is in the power-saving mode. At this time, the monitor unit 431 of the mode control unit 43 monitors the state of the operation panel 46, the network unit 47, the FAX unit 48 and the like.

At step S2, when the user operates the operation panel 46, or the network unit 47 or the FAX unit 48 receives a reception signal, at step S2, the monitor unit 431 inputs an interrupt signal to the main CPU 42. By this, at step S3, the main CPU 42 returns to the normal state from the SLEEP mode.

Next, the main CPU 42 releases the self-refresh mode of the main memory 45, and at next step S4, it is determined whether the distinguishing process of the return factor is necessary. That is, in the case where the operation panel 46 is operated by the user, it is necessary to immediately make a return to the normal mode without performing the distinguishing process, however, in the case where a packet is received in the network unit 47, there is a case where it is unnecessary to make a return to the normal mode.

Accordingly, at step S4, it is determined whether it is necessary to distinguish the return factor. The necessity of the distinguishing process here is determined such that a designer previously classifies respective return factors, and they are distinguished in software.

For example, in the case where the operation panel 46 is operated by the user, since it is necessary to make a return to the normal mode immediately without especially performing the distinguishing process, a shift is made to step S5 and the return to the normal mode is made.

On the other hand, in the case where a packet is received in the network unit 47, it is necessary to distinguish whether the packet data is sent to an indefinite number of image forming apparatuses or is sent to its own image forming apparatus. Accordingly, at step S4, it is determined to be necessary to distinguish the return factor, and a shift is made to step S6 and the distinguishing process is performed.

Here, as packets to be transmitted and received on the network, there are, for example, following ones.

Broad-cast packet: Data is transmitted from an apparatus to an indefinite number of apparatuses on the network.

Multi-cast packet: The same data is transmitted from an apparatus to a plurality of specified apparatuses on the network.

Uni-cast packet: Data is transmitted from an apparatus to a specific single apparatus on the network.

ARP packet: A packet for inquiring a MAC address based on an IP address. An apparatus in which the same IP address as the IP address of the inquiry is set sends back a packet in which its own MAC address is stored, and data is exchanged based on that.

Among the above four packets, with respect to the uni-cast packet and the ARP packet, when the packet is designated for itself, it is necessary to respond thereto, and when the packet is data to instruct printing, it is necessary to perform a print job.

For that purpose, at step S6, the main CPU 42 distinguishes the return factor in accordance with a dedicated program stored in the main memory 45, and distinguishes the content of packet data with respect to the packet sent to its own image forming apparatus through the network.

At step S7, based on the distinguishing result, it is determined whether a return to the normal mode is necessary, and when the return is necessary, a shift is made to step S5, and the return is made to the normal mode. Besides, in the case where it is determined at step S7 that the return is not necessary, a shift is made to step S8, a return is made to the power-saving mode, and the process is ended at step S9.

For example, at step S7, in the case where it is determined to be necessary to perform a reception process of FAX or a print process, it is necessary to make a return to the normal mode, and accordingly, a shift is made to step S5. In the case where it is not necessary to perform the print process, a shift is made to step S8, and a return is made to the power-saving mode without returning to the normal mode.

At step S7, in the case where it is determined that the return to the normal mode is necessary, the main CPU 42 controls the power source control unit 432 to start the main power source 61, and the power source voltage is supplied to the main power source system 50. By this, the return to the normal mode is made. In the case where it is determined that the return is not necessary, the main memory 45 is immediately returned to the self-refresh mode, the main CPU 42 is placed in the SLEEP mode, and the return to the power-saving mode is made.

Incidentally, each time an event of a return factor occurs, the main CPU 42 is shifted from the SLEEP mode to the normal state, the main memory 45 is also shifted from the self-refresh mode to the normal state, and it is distinguished whether the image forming apparatus 1 is to be returned to the normal mode. However, the distinguishing process itself takes only 1 to 2 seconds at the most, and the distinguishing process at this time is performed without starting the main power source system 50, and therefore, the power consumption can be made small. Accordingly, on the whole, a sufficiently great power-saving effect can be expected.

As described above, in the embodiment of the invention, the state of the image forming apparatus is monitored, and a return is made from the power-saving mode to the normal mode as the need arises, and therefore, the power consumption can be greatly reduced. Besides, when the image forming apparatus is operated in the power-saving mode, the main CPU is operated in the low power consumption state, and the main memory is operated in the self-refresh mode, and therefore, the power consumption can be efficiently reduced.

Incidentally, no limitation is made to the above description, and various modifications can be made within the scope not departing from the claims.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. An image forming apparatus operating in a normal mode and a power-saving mode having smaller power consumption than the normal mode, comprising:
a control unit that includes a CPU and a memory, controls the image forming apparatus in the normal mode and the power-saving mode, operates the CPU in a low power consumption state and operates the memory in a self-refresh mode to hold data in the power-saving mode; and
a power source circuit that supplies a power source voltage to each unit of the image forming apparatus in the normal mode, and stops power supply to a circuit unit whose operation is not required in the power-saving mode,
wherein the control unit monitors a state of the image forming apparatus, and when a return factor to the normal mode from the power-saving mode occurs, the control unit operates the CPU and the memory in a normal state to distinguish whether a return to the normal mode is to be made, and returns the image forming apparatus to the normal mode according to a distinguishing result.

2. The image forming apparatus according to claim 1, wherein in the normal mode, the CPU operates in the normal state, and in the power-saving mode, the CPU operates in a SLEEP mode which stops instruction execution and clock supply.

3. The image forming apparatus according to claim 1, wherein distinguishing of the return to the normal mode in the control unit is carried out by the CPU in accordance with a distinguishing program prepared in the memory.

4. The image forming apparatus according to claim 3, wherein
the CPU returns to the normal state immediately in a case where a return factor to the normal mode occurs in the power-saving mode,
in a case where the return factor requires a distinguishing process in the CPU, the distinguishing program of the memory is operated, and the image forming apparatus is returned to the normal mode according to the distinguishing result, and
in a case where the return factor requires the return to the normal mode without performing the distinguishing process in the CPU, an Operation System of the memory is immediately started, and the image forming apparatus is returned to the normal mode.

5. The image forming apparatus according to claim 4, wherein as a result of distinguishing the return factor, in a case where it is determined that the return to the normal mode is unnecessary, the control unit returns the CPU to the low power consumption state.

6. The image forming apparatus according to claim 1, wherein, in order to monitor the state of the image forming apparatus, the control unit includes a monitor unit to monitor an operation panel of the image forming apparatus and a state of a communication unit to an external apparatus.

7. The image forming apparatus according to claim 6, wherein the communication unit includes a network unit and a FAX unit, and the monitor unit monitors an operation of the operation panel by a user, or signal reception in the network unit and the FAX unit.

8. The image forming apparatus according to claim 7, wherein in the power-saving mode, in a case where a predetermined packet is received in the network unit, the CPU distinguishes content of the packet by a distinguishing program prepared in the memory, and determines whether the return to the normal mode is to be made.

9. The image forming apparatus according to claim 8, wherein the packet is one of a uni-cast packet and an ARP packet.

10. The image forming apparatus according to claim 1, wherein
the power source circuit includes a main power source to supply a power source voltage to an image forming unit, and a sub-power source to supply a power source voltage to other circuit units including the control unit, and
under control of the control unit, the main power source and the sub-power source are operated in the normal mode, and the main power source is stopped in the power-saving mode.

11. The image forming apparatus according to claim 10, wherein the image forming unit includes a scanner unit and a printer unit.

12. A control method for operating an image forming apparatus in a normal mode and a power-saving mode having smaller power consumption than the normal mode, comprising:
supplying a power source voltage to each unit of the image forming apparatus in the normal mode;
stopping, in the power-saving mode, supply of the power source voltage to a circuit unit whose operation is not required, operating a CPU of a control unit in a low power consumption state, and operating a memory of the control unit in a self-refresh mode to hold data;
monitoring a state of the image forming apparatus by the control unit when the image forming apparatus operates in the power-saving mode;
operating the CPU and the memory in a normal state when a return factor to the normal mode occurs, and distinguishing whether a return to the normal mode is to be made; and
returning the image forming apparatus to the normal mode according to a distinguishing result.

13. The control method according to claim 12, wherein in the normal mode, the CPU operates in the normal state, and in the power-saving mode, the CPU operates in a SLEEP mode which stops instruction execution and clock supply.

14. The control method according to claim 12, wherein distinguishing as to the return to the normal mode is carried out by the CPU in accordance with a distinguishing program prepared in the memory.

15. The control method according to claim 14, wherein
the CPU returns to the normal state immediately in a case where a return factor to the normal mode occurs in the power-saving mode,
in a case where the return factor requires a distinguishing process in the CPU, the distinguishing program of the memory is operated, and the image forming apparatus is returned to the normal mode according to the distinguishing result, and
in a case where the return factor requires the return to the normal mode without performing the distinguishing process in the CPU, an Operation System of the memory is immediately started, and the image forming apparatus is returned to the normal mode.

16. The control method according to claim 15, wherein as a result of distinguishing the return factor, in a case where it is determined that the return to the normal mode is unnecessary, the CPU is returned to the low power consumption state.

17. The control method according to claim 12, wherein the control unit monitors an operation panel of the image forming apparatus and a state of a communication unit including a network unit.

18. The control method according to claim 17, wherein the control unit monitors an operation of the operation panel by a user, or signal reception in the communication unit, and in a case where a predetermined packet is received in the network unit, the CPU distinguishes content of the packet by a distinguishing program prepared in the memory, and determines whether the return to the normal mode is to be made.

19. The control method according to claim 18, wherein the predetermined packet is one of a uni-cast packet and an ARP packet.

20. The control method according to claim 12, wherein
in the normal mode, a power source voltage is supplied to each unit of the image forming apparatus including the control unit, and
in the power-saving mode, supply of the power source voltage to an image forming unit is stopped.
